(19) United States
(12) Patent Application Publication
(10) Pub. No.: US 2019/0281603 A1
(43) Pub. Date: Sep. 12, 2019

(54) CHANNEL CONTROL METHOD AND APPARATUS IN VEHICLE-TO-EVERYTHING COMMUNICATIONS

(71) Applicant: Electronics and Telecommunications Research Institute, Daejeon (KR)

(72) Inventors: Hyun Seo OH, Daejeon (KR); Do Wook KANG, Daejeon (KR)

(73) Assignee: Electronics and Telecommunications Research Institute, Daejeon (KR)

(21) Appl. No.: 16/138,320

(22) Filed: Sep. 21, 2018

(30) Foreign Application Priority Data
Mar. 12, 2018 (KR) 10-2018-0028768

(51) Int. Cl. H04W 72/04; H04W 72/08; H04W 4/40; H04B 17/382; H04B 17/318; H04B 17/336; H04B 17/364

(52) U.S. Cl. CPC H04W 72/0453; H04W 72/085; H04W 72/0486; H04B 17/364; H04B 17/382; H04B 17/318; H04B 17/336; H04W 4/40

(57) ABSTRACT

A channel control method and apparatus for improving the transmission capacity of packet data and communications reliability in V2X vehicle packet communications. In V2X wireless communications, the number and bandwidths of transmission channels are predetermined. The control method monitors signal levels received between transceivers and the frequency of channel usage, and based on the result. of the monitoring, varies at least one of the bandwidth of frequency channels and the number of transmission channels. The control method is adaptive to wireless channels. The bandwidth of a transmission channel is variably assigned to, depending on whether the channel status for signal reception is good or bad. The number of transmission channels is variably assigned to, depending on whether the usage frequency of a reception channel is low or high.

### CROSS REFERENCE TO RELATED APPLICATION

The present application claims priority to Korean Patent Application Number 10-2018-0028768, filed on Mar. 12, 2018, the entire contents of which are incorporated herein for all purposes by this reference.

### BACKGROUND

### Field

The present disclosure relates to a channel control technology for improving the transmission capacity of packet data and communications reliability in Vehicle-to-Everything (V2X) packet communications.

### Description

V2X (Vehicle-to-Everything) communications refer to the passing of information from a vehicle to any entity, or vice versa. The term “V2X communications” includes vehicle-to-vehicle (V2V) wireless communication, vehicle-to-infrastructure (V2I) wireless communication, vehicle-to-pedestrian (V2P) communication, and the like. It is possible to improve an information environment, safety, convenience, and the like between vehicles and roads using V2X communications.

V2X communications typically use wireless access in vehicular environments (WAVE) communication technology in the 5.9 GHz spectrum to provide cooperative intelligent transport system (C-ITS) services while ensuring safety to vehicles. This technology provides 90% packet transmission reliability by providing a packet time response of 100 msec in high-speed mobile environments.

In actual applications of this technology, a problem of congestion. may occur in an urban. environment in which vehicles are densely distributed. In particular, autonomous driving requires enhancements in the capability and reliability of V2X communications, due to rapidly increasing amounts of data included vehicle safety and control data transmissions. When a plurality of vehicles are engaged in communications in an urban environment, congestion may occur, thereby lowering the performance of communications. To overcome this problem, it is necessary to enhance the transmission capacity of wireless communications. In addition, to support autonomous driving control, the reliability of packet communications must be improved.

Accordingly, to support vehicle safety services and autonomous driving control services in a situation in which hundreds of vehicles are densely distributed in an urban area, a solution able to provide high-speed data transmissions of about 100 Mbps and at least 99% packet reception ratio is demanded.

### BRIEF SUMMARY

A channel control method and apparatus in V2X communications according to the present disclosure is proposed to improve transmission capacity and communication reliability in V2X communications.

A preset number of channels having a preset bandwidth are used for transmissions in V2X communications. For example, WAVE communication uses control channels and service channels, in which a channel bandwidth of 10 MHz or 20 MHz may be assigned to the service channels. The present disclosure relates to a control method of monitoring signal levels received between transceivers, and the frequency of channel usage, then based on the result of the monitoring, varying at least one of the bandwidth of channels and the number of transmission channels. The control method may be adaptive to wireless channels.

According to a first aspect of the present disclosure, a channel control method may variably assign the bandwidth of a transmission channel depending on whether or not the channel status for signal reception is good (i.e., acceptable).

Specifically, the channel status may be detected to be or not to be good by monitoring the reception channel status. When the channel status is good, a first bandwidth may be assigned to a channel to transmit data. When the channel status is bad (i.e., unacceptable), a second bandwidth may be assigned to the channel to transmit data.

Here, the first bandwidth may be greater than the second bandwidth. Values of the first and second bandwidths may vary depending on types of communications, on which V2X communications are based.

The good or bad channel status may be detected by comparing one of RSSI (received signal strength indication) value, SNR (signal-to-noise ratio), and a delay spread value of a received signal, to a preset reference value.

According to a second aspect of the present disclosure, a channel control method. may variably assign the number of transmission channels depending on whether or not the usage frequency of a reception channel is low or high. Specifically, the usage frequency of the reception channel is compared to be lower than a preset reference value by monitoring the usage frequency of the reception channel. When the usage frequency of the reception channel is lower than the preset reference value, a single transmission channel may be assigned to. On the other hand, when the usage frequency of the reception channel is not lower than the preset reference value, two or more transmission channels may be assigned to. The usage frequency, or a reception ratio, of the reception channel may be estimated from a frequency of CCA (clear channel assessment), RSSI value, and the like.

When the two or more transmission channels are assigned to, different data may be transmitted. via the assigned transmission channels, respectively; or the same data may be transmitted via all of the assigned transmission channels.

According to a third aspect of the present disclosure, combining the above-described methods according to the first and second aspects, the channel control method may detect whether or not the channel status for signal reception is good and whether the usage frequency of a reception channel is low or high. Then, based on a result of the decision, the bandwidths and number of transmission channels are variably assigned to.

Specifically, the reception channel may be monitored. Depending on whether or not the channel status of the reception channel is good, the bandwidths of the transmission channels may be variably assigned to. Depending on whether or not the usage frequency of the reception channel is low or high, the number of the transmission channels may be variably assigned to.

The procedure of monitoring the channel status of the reception channel and the procedure of variably assigning the channel bandwidths, as well as the procedures of monitoring the usage frequency of the reception channel and variably assigning the number of the channels, may be the same as those described above regarding the first and the second aspects.

According to a fourth aspect of the present disclosure, a channel control apparatus may include: in addition to a sender for transmitting data and also in addition to a receiver for receiving radio frequency (RF) signals, a channel monitor for monitoring a channel status for signal reception of the receiver; and a channel scheduler for changing at least one of bandwidths and number of transmission channels in the sender, based on a result of the monitoring.

The channel monitor may include a channel status detecter for detecting whether a channel status for signal reception is good or bad and a channel usage frequency detecter for detecting whether the usage frequency of a reception channel is low or high.

The good or bad channel status may be detected by comparing one of RSSI value, SNR, and a delay spread value of a received signal, to a preset reference value. When the channel status is good, the channel scheduler may assign a first bandwidth to a channel to transmit data. When the channel status is bad, the channel scheduler may assign. a second bandwidth to the channel to transmit data.

Here, the first bandwidth may be greater than. the second bandwidth. Values of the first and second bandwidths may vary depending on types of communications, on which V2X communications are based.

In addition, the channel usage frequency detecter may detect the usage frequency, or usage ratio, of the reception channel for a predetermined period of time. When the usage frequency of the reception channel is detected to be not lower than a preset reference usage ratio level, the channel scheduler may assign two or more transmission channels to the sender. When. the usage frequency of the reception channel is detected to be lower than the preset reference usage ratio level, the channel scheduler may assign a single transmission channel to the sender.

When the two or more transmission channels are assigned to, different data may be transmitted via the assigned transmission channels, respectively; or the same data may be transmitted via all of the assigned transmission. channels.

The configurations and operations of the present disclosure will be more clearly understood from the following detailed description. when. taken in conjunction with the accompanying drawings.

According to at least one of exemplary embodiments, in V2X communications based on WAVE communication standards, it is possible to multiply the data transmission rate by up to four times while maintaining compatibility with existing standards. In the case of a vehicle safety service provided using WAVE communication technology in an urban environment, about 50 terminals may be engage in communications. Although an increase in the number of terminals may degrade the performance of communications due to congestion, the above-described transmission method can overcome the problems of congestion by multiplying the number of terminals capable of communication by about four times. In addition, when the same data is transmitted via two channels, diversity approach can be applied to both a sender and a receiver, thereby advantageously improving the reliability of data transmissions.

### BRIEF DESCRIPTION OF THE DRAWINGS

FIG. 1 is a process flowchart illustrating a channel control method according to an exemplary embodiment;

FIG. 2 is a process flowchart illustrating a channel control method according to another exemplary embodiment;

FIG. 3 is a process flowchart illustrating a channel control method according to further another exemplary embodiment;

FIG. 4 is a block diagram illustrating a configuration of channel control apparatus according to an exemplary embodiment; and

FIGS. 5 to 8 are channel scheduling diagrams illustrating the operation of the channel control method and apparatus according to an exemplary embodiment, in which:

FIG. 5 illustrates the concept of operating a single 20 MHz channel when the reception channel status is good;

FIG. 6 illustrates the concept of operating two 20 MHz channels when the reception channel status is good;

FIG. 7 illustrates the concept of operating a single 10 MHz channel when the reception channel status is bad; and

FIG. 8 illustrates the concept of operating two 10 MHz channels when the reception channel status is bad.

### DETAILED DESCRIPTION

Hereinafter, the present disclosure will be described in detail with reference to exemplary embodiments of a channel resource scheduling (channel control) apparatus and method in V2X communications based on WAVE communication standards used in vehicle safety and cooperative intelligent transport system (C-ITS) application services.

According to WAVE communication standards, a single control channel (CCH) and six service channels (SCH) are provided. When two senders are envolved, data can be simultaneously transmitted via the control channel and the service channels. When two channels are used in WAVE communication, a 10 or 20 MHz channel bandwidth can be utilized. An OFDM (orthogonal frequency-division multiplexing) signal using 10 MHz bandwidth and an OFDM signal using 20 MHz bandwidth have different OFDM symbol lengths and data rates. The 10 MHz bandwidth has a symbol length of 3.2 μsec and a data rate of 27 Mbps, while the 20 MHz bandwidth has a symbol length of 6.4 μsec and a data rate of 54 Mbps. It can be understood that the 20 MHz bandwidth is used in short-distance communications and the 10 MHz bandwidth is more appropriate for use in the case of longer distances.

In addition, a single channel is used when the frequency of channel usage is low, while it is necessary to use two channels to increase transmission capacity when the frequency of channel usage becomes higher. It is possible to operate channels to be more appropriate for channel situations by variably controlling the transmission bandwidth and the number of channels used, by measuring the channel status for signal reception and the frequency of channel usage.

Table 1 represents a channel control method according to an exemplary embodiment. Table 1 represents an exemplary method of variably assigning transmission channels depending on whether the channel status for signal reception is acceptable (good) or unacceptable (bad).

TABLE 1

| Status of reception | Transmission Channel |
|---|---|
| channel | Assignment |
| Acceptable (Good) | 20 MHz bandwidth |
| | channel |
| Unacceptable (Bad) | 10 MHz bandwidth |
| | channel |

Table 2 represents an exemplary method of variably assigning transmission channels depending on whether the usage frequency of the reception channel is low or high.

TABLE 2

| Usage frequency of | Transmission Channel |
|---|---|
| reception channel | Assignment |
| Low | 1 channel |
| High | 2 channels |

Table 3 represents an exemplary method of variably assigning transmission channels depending on whether the channel status for signal reception is good or bad and whether the usage frequency of the reception channel is low or high. That is, Table 3 represents a channel scheduling method in which the embodiment represented in Table 1 and the embodiment represented in Table 2 are combined.

TABLE 3

| Reception channel | Usage frequency of | Transmission Channel |
|---|---|---|
| status | reception channel | Assignment |
| Good | Low | Single 20 MHz bandwidth |
| | | channel |
| Good | High | Two 20 MHz bandwidth |
| | | channels |
| Bad | Low | Single 10 MHz bandwidth |
| | | channel |
| Bad | High | Two 10 MHz bandwidth |
| | | channels |

FIG. 1 is a process flowchart illustrating a channel control method according to an exemplary embodiment (i.e. the method represented in Table 1). In 10, the reception channel status on RF stage of a receiver is monitored. In 12, it is detected whether or not the channel status is good. The channel status is detected to be good or bad through comparison to a received signal strength indication (RSSI) value, signal-to-noise ratio (SNR), and delay spread value, which are predefined as references. If the channel status is good, data transmitted via 20 MHz bandwidth assigned to a service channel in 14. If the channel status is bad, data is transmitted via 10 MHz bandwidth assigned to the service channel, in 16. Here, the 20 and 10 MHz bandwidths are bandwidths in the case in which WAVE communications are used as in the present embodiment. Of course, in other communication methods these bandwidths may be changed.

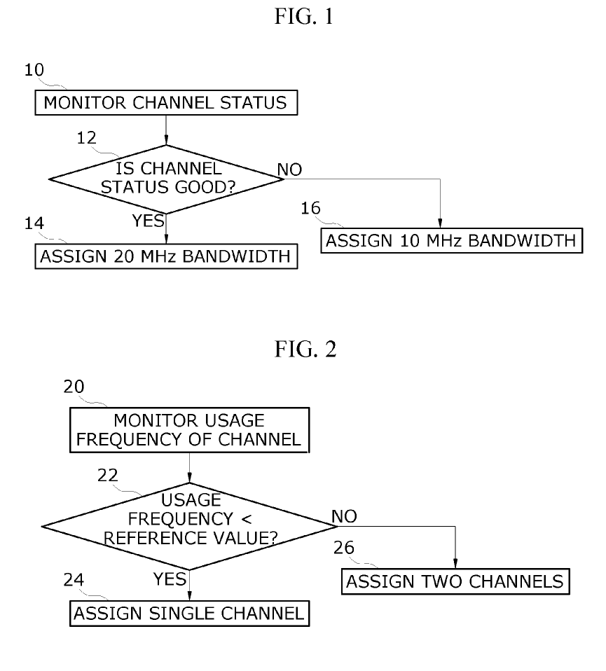

FIG. 2 is a process flowchart illustrating a channel control method according to another exemplary embodiment. (i.e. the method represented in Table 2). In 20, the frequency (or rate) of usage of the reception channel on an RF stage of a receiver is monitored. In 22, it is detected whether or not the usage frequency of the reception channel is lower than a preset reference value (or a reference usage ratio) through comparison. When the usage frequency of the reception channel is lower than the reference usage ratio, a single service channel is assigned to in 24. When the usage frequency of the reception channel is not lower than the reference usage ratio, two service channels are assigned to in 26. The usage frequency (or reception ratio) of the reception channel may be estimated from a frequency of clear channel assessment (CCA), RSSI value, or the like.

In another embodiment, the method according to the present disclosure can be provided by combining the processes of FIGS. 1 and 2. In an exemplary method, the processes of FIGS. 1 and 2 may be combined in series. (For example, the process of FIG. 2 may be performed after the process of FIG. 1, or vice versa.) In another exemplary method, the method represented in Table 3 may be provided by combining the processes of FIGS. 1 and 2 in parallel.

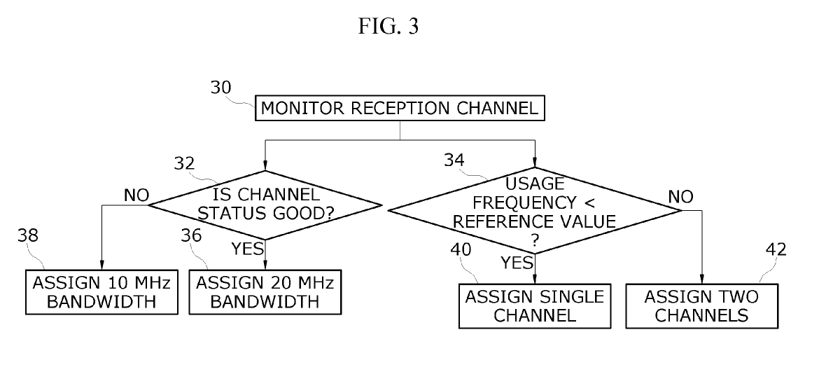

FIG. 3 is a process flowchart illustrating a combined channel control method according to further another exemplary embodiment (i.e. the method represented in Table 3), in which the processes of FIGS. 1 and 2 are combined. in parallel.

In 30, a reception channel on an RF stage of a receiver is monitored. The monitoring 30 includes monitoring the channel status of the reception channel (32) and monitoring the usage frequency of the reception channel (34).

In the monitoring 32 of the channel status of the reception channel, it is detected whether or not the channel status is good. after monitoring the status of the reception channel on the RF stage of the receiver. If the channel status is good, a 20 KHz bandwidth is assigned to a service channel to transmit data in 36. If the channel status is bad, a 10 MHz bandwidth is assigned to the service channel to transmit data in 38.

In the monitoring 34 of the usage frequency of the reception channel, the usage frequency (or usage ratio) of the reception channel is detected whether or not to be lower than a preset reference value by monitoring the usage frequency of the reception channel on the RF stage of the receiver. When the usage frequency of the reception channel is lower than the preset reference usage ratio, single service channel is assigned to in 40. When the usage frequency of the reception channel is not lower than the preset reference usage ratio, two service channels are assigned to in 42.

In the embodiment illustrated in FIG. 3, the procedural order of monitoring the channel status of the reception channel (32) and monitoring the usage frequency of the reception channel (34) is random. For example, 1) the monitoring of the channel status of the reception channel 32 and the monitoring of the usage frequency of the reception channel 34 may be simultaneously performed, 2) the monitoring 32 may be performed before the monitoring 34, or 3) the monitoring 32 may he performed after the monitoring 34.

In addition, the subsequent tasking procedures 36, 38, 40, and 42 are not required to be performed time-sequentially: i.e., these procedures may not be performed in the sequence illustrated in FIG. 3. For example, the procedures 36, 38, 40, and 42 may be performed after data is stored in a buffer (or temporary memory) through the execution of the procedures 32 and 34.

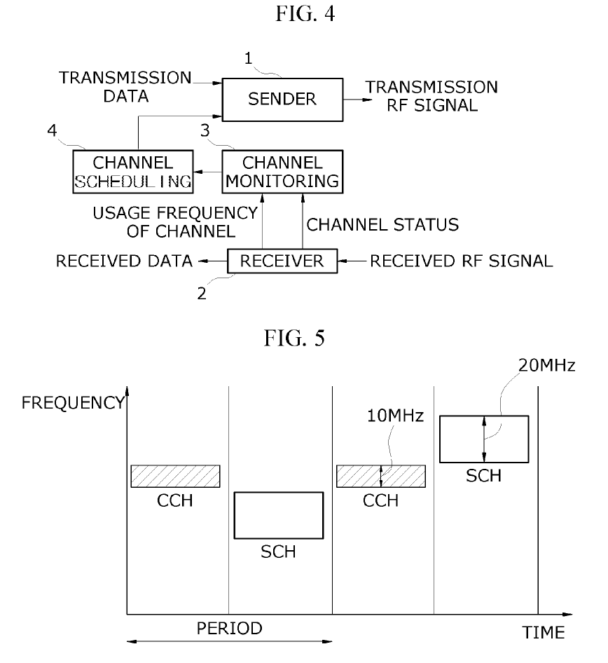

FIG. 4 is a block diagram illustrating a configuration of a communications apparatus for implementing the transmission channel control method presented in Tables 1 to 3.

The communications apparatus illustrated in FIG. 4 includes a sender 1 for transmitting data, a receiver 2 for receiving incoming RF signals, a channel monitor 3 for monitoring the channel status for signal reception and the usage frequency of a reception channel, and a channel scheduler 4 for controlling the sender 1 to change the bandwidths and number of transmission channels.

The channel monitor 3 detects an RSSI value, an SNR, and a delay spread value of the channel to monitor the channel status of the received signal. The channel status is detected to be good or bad by comparing the RSSI value, SNR, and delay spread value, to the preset threshold values thereof. If the channel status is detected to be good through comparison to a specific threshold value, the channel scheduler 4 controls the sender 1 to have a 20 MHz service channel bandwidth, as represented in Table 1. If the channel status is detected to be not good as a result of monitoring the RSSI value, SNR, and delay spread value of the receiving signal, the channel scheduler 4 controls the sender 1 to have a 10 MHz service channel bandwidth.

In addition, the procedure of monitoring the usage frequency of the reception channel, i.e. the second function of the channel monitor 3 (see Table 2), will be described. The channel monitor 3 monitors the usage frequency or the usage ratio (or reception ratio) of the reception channel for a predetermined period of time. If the usage ratio is higher than a preset usage ratio, the channel monitor 3 detects that the usage frequency is not lower, and the channel scheduler controls the sender 1 to have two service channels. If the usage ratio is lower than the preset usage ratio, the channel monitor 3 detects that the usage frequency is low, and the channel scheduler 4 controls the sender 1 to have a single service channel.

In FIG. 4, the channel monitor 3 can monitor the usage frequency of the channel and the channel status on the RF receiving stage of the receiver. Since the receiver generally includes the RF receiving stage and a modem, the usage frequency of the channel and the channel status can be monitored from a signal transferred from the RF receiving stage to the modem. The monitoring can be performed using a comparator circuit constructed of hardware or using a software technology.

The channel scheduler 4 transfers a comparison result signal, outputted from the channel monitor 3, to the sender 1 to control the resource configuration function or register mode setup of the sender 1.

FIGS. 5 to 8 illustrate channel scheduling diagrams illustrating the operation of a channel control method according to an exemplary embodiment.

FIG. 5 illustrates a case fe which a single 20 MHz channel bandwidth is assigned to when the reception channel status is good. A control channel CCH and a service channel SCH are operated in multi-channel modality, wherein the control channel CCH operating in a 10 MHz bandwidth, and the service channel SCH operating in a 20 MHz bandwidth. In the case illustrated in FIG. 5, the status of a reception channel and the usage frequency of the channel in a CCH section are monitored as represented in Table 3, and transmission is performed via a single channel SCH of 20 MHz bandwidth.

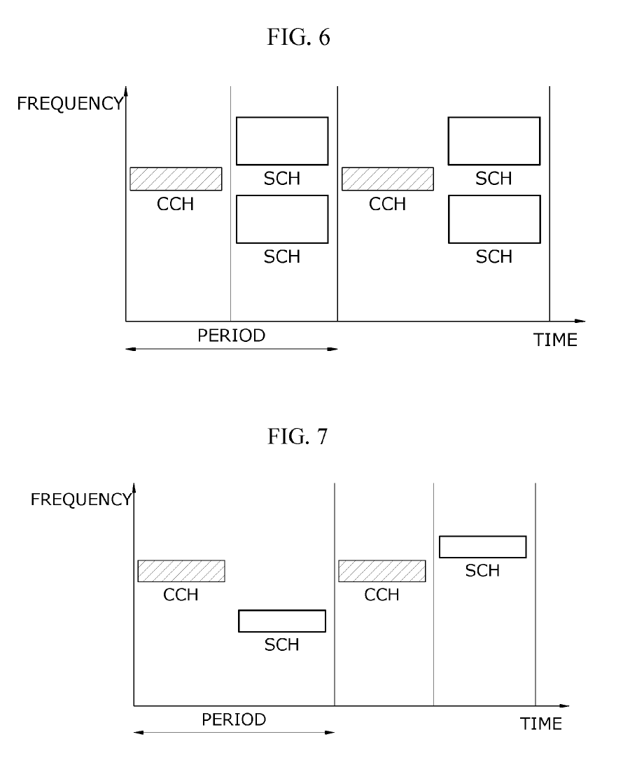

FIG. 6 illustrates a case in which additional channel scheduling is necessary due to an increase in the usage frequency of a channel. Transmission is performed using two service channels of 20 MHz bandwidth.

FIG. 7 illustrates a case in which 10 MHz bandwidth is used because the reception channel status is bad. The status of a reception channel and the usage frequency of the channel in a CCH section are monitored, and transmission is performed via a single channel of 10 MHz bandwidth suitable to the relevant channel status.

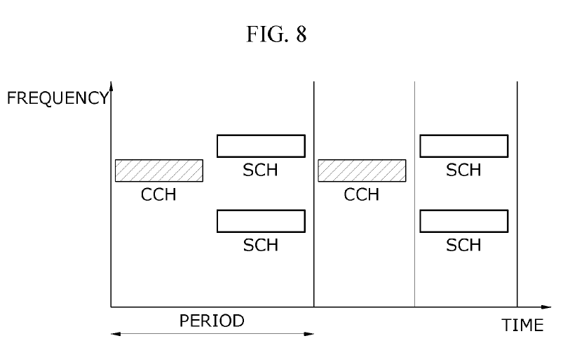

FIG. 8 illustrates a case in which two 10 MHz channels are used. for transmission, due to an increase in the usage frequency of the channel.

As described. above, the present disclosure can. vary the bandwidth and number or transmission frequency channels (i.e. service channels) depending on. the channel status in wireless communications. This can consequently overcome the problem. of congestion and resultant performance degradation due to communication of densely distributed. vehicles, thereby increasing the overall capacity of communications.

In additional description, when two service channels are assigned to as in the cases of FIGS. 6 and 8, either different data or the same data may be transmitted via the service channels. In the former case, the capacity of transmission data can be increased, since data is transmitted via each channel. In the latter case, since the same data is transmitted via two channels, the effect of transmission diversity can be obtained, thereby improving the reliability of communications.

The foregoing embodiments as set forth above are specific examples for embodying the technical principle of the present disclosure. It should be understood that the scope of the present disclosure be defined by the appended Claims.

What is claimed is:

1. A channel control method for V2X vehicle packet communications, the method comprising:
detecting whether or not channel status is good by monitoring reception channel status;
when the channel statue is good, assigning a first bandwidth to the channel; and
when the channel status is bad, assigning a second bandwidth to the channel,
wherein the first bandwidth is greater than the second bandwidth.

2. The channel control method according to claim 1, wherein detecting whether or not the channel status is good is performed by comparing one selected from a group consisting of a received signal strength indication (RSSI) value, a signal-to-noise ratio (SNR), and a delay spread value of a received signal, to a preset reference value.

3. A channel control method for V2X vehicle packet communications, the method comprising:
comparing whether or not a usage frequency of a reception channel is lower than a preset reference value by monitoring the usage frequency of the reception channel;
when the usage frequency of the reception channel is lower than the preset reference value, assigning a single transmission channel; and
when the usage frequency of the reception channel is not lower than the preset reference value, assigning two or more transmission channels.

4. The channel control method according to claim wherein the reference value, based on which the usage frequency of the reception channel is detected to be low or not, is one selected from a group consisting of a frequency of clear channel assessment (CCA) and a received signal strength indication (RSSI) value.

5. The channel control method according to claim 3, wherein, when the two or more transmission channels are assigned to, different data are transmitted via the assigned transmission channels, respectively.

6. The channel control method according to claim 3, wherein, when the two or more transmission. channels are assigned to, same data is transmitted via all of the assigned transmission channels.

7. The channel control method according to claim 1, further comprising:
comparing whether or not a usage frequency of a reception channel is lower than a preset reference value by monitoring the usage frequency of the reception channel;
when the usage frequency of the reception channel is lower than the preset reference value, assigning a single transmission channel; and
when the usage frequency of the reception channel is not lower than the preset reference value, assigning two or more transmission channels.

8. The channel control method according to claim wherein detecting whether or not the channel status is good is performed by comparing one selected from a group consisting of a received signal strength indication (RSSI) value, a signal-to-noise ratio (SNR), and a delay spread value of a received signal, to a preset reference value.

9. The channel control method according to claim 7, wherein the reference value, based on which the usage frequency of the reception channel is detected to be low or not, is one selected from a group consisting of a frequency of clear channel assessment (CCA) and a received signal strength indication (RSSI) value.

10. The channel control method according to claim 7 wherein, when the two or more transmission channels are assigned to, different data are transmitted via the assigned transmission channels, respectively.

11. The channel control method according to claim 7 wherein, when the two or more transmission channels are assigned to, same data is transmitted via all of the assigned transmission channels.

12. A channel control apparatus for V2X vehicle packet communication including a sender for transmitting data and a receiver for receiving radio frequency (RF) signals, the apparatus comprising:
a channel monitor for monitoring a channel of a receiving signal of the receiver; and
a channel scheduler for controlling at least one of bandwidths and number of transmission channels in the sender, based on a result of the monitoring.

13. The channel control apparatus according to claim 12, wherein the channel monitor comprises a channel status detecter for detecting whether a channel status for signal reception is good or bad,
wherein, when the channel status is good, a first bandwidth is assigned to the channel, and when the channel status is bad, a second bandwidth is assigned to the channel, the first bandwidth being greater than the second bandwidth.

14. The channel control apparatus according to claim 13, wherein the channel status is detected to be good or bad by comparing one selected from a group consisting of a received signal strength indication (RSSI) value, a signal-to-noise ratio (SNR), and a delay spread value of a received signal, to a preset reference value.

15. The channel control apparatus according to claim 12, wherein the channel monitor comprises a channel usage frequency detecter for detecting whether a usage frequency of a reception channel is low or high,
wherein, when the usage frequency of the reception channel is lower than the preset reference value, a single transmission channel is assigned to, and when the usage frequency of the reception channel is not lower than the preset reference value, two or more transmission channels are assigned to.

16. The channel control apparatus according to claim 15, wherein the reference value, based on which the usage frequency of the reception channel is detected to be low or not, is one selected from a group consisting of a frequency of clear channel assessment (CCA) and a received signal strength indication (RSSI) value.

17. The channel control apparatus according to claim 15, wherein, when the two or more transmission channels are assigned to, different data are transmitted via the assigned transmission channels, respectively.

18. The channel control apparatus according to claim 15, wherein, when the two or more transmission channels are assigned to, same data is transmitted via all of the assigned transmission channels.
